(19) United States
(12) Patent Application Publication
(10) Pub. No.: US 2004/0008280 A1
(43) Pub. Date: Jan. 15, 2004

(54) Information handling system featuring a display device with non-linear brightness level adjustment

(75) Inventor: Gary J. Verdun, Belton, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/191,556

(22) Filed: Jul. 9, 2002

(51) Int. Cl. H04N 9/76

(52) U.S. Cl. 348/600

(57) ABSTRACT

An information handling system is disclosed which employs non-linear brightness steps to make it appear to the user that brightness steps from minimum to maximum brightness and maximum to minimum brightness are substantially the same with respect to brightness change from step to step. Prior systems employed brightness steps which incremented brightness levels substantially linearly from brightness level to brightness level. Unfortunately such linear systems leave the user with the impression that there is very little change in brightness from step to step as maximum brightness is approached. In one disclosed embodiment, the information handling system employs brightness steps which change the brightness level by an approximately fixed percentage of brightness as the brightness level is changed from step to step.

### BACKGROUND

The disclosures herein relate generally to information handling systems and more particularly to adjusting the brightness of displays associated with such information handling systems.

As the value and use of information continue to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally utilize display devices to output visual information, such as texts and graphics. Types of display devices include cathode ray tube (“CRT”) monitors used with most personal computers (“PC”), and liquid crystal display (“LCD”) panels adapted for use with most portable computers as well as PC's. Display devices commonly include adjustable brightness settings to accommodate various operating conditions. Currently, brightness settings are adjustable linearly, in fixed increments and decrements. For example, an LCD display device typically used in a portable computer may have total of 8 brightness settings ranging from 1 to 8. Brightness level of cold cathode fluorescent lamps (“CCFL's”), commonly used to provide the backlight in such LCD display devices, is typically measured in NITS. Assuming that the minimum brightness level is 20 NITS and that the maximum brightness level is 160 NITS, each adjustment to the brightness settings would result in change of brightness level by 20 NITS.

However, human eyes do not perceive the actual difference in the levels of brightness when adjustments are made to brightness settings. Instead, human eyes perceive the difference between the brightness level before an adjustment and the brightness level after the adjustment as a percentage of the brightness level prior to the adjustment. Thus, a disadvantage of the current practice of adjusting brightness level linearly is that, to users, each change in brightness level will appear to be disproportionately significant at lower brightness settings and disproportionately trivial at higher brightness settings. Therefore, users are provided with perception that changes in brightness level are inconsistent when settings are adjusted.

Another disadvantage of current practice of adjusting brightness is that, under some conditions, display devices operate at brightness settings that are needlessly high, causing greater power consumption. This may occur because at higher brightness settings, users are unable to perceive, or have difficult perceiving changes in brightness levels, causing users to increase brightness levels beyond what may be appropriate for a given operating condition. Reducing power consumption is especially critical in battery operated information handling systems, such as portable computers.

Therefore, what is needed is a way to provide users with the perception that, when brightness level settings of a display device are adjusted from level to level, the resultant changes in brightness level appear to be more consistent. Moreover, it is desirable to provide a way to achieve reduced display power consumption when changing display brightness levels.

### SUMMARY

Accordingly, in one embodiment, an information handling system is provided wherein the information handling system includes a processor and a memory coupled to the processor. The system also includes a display device coupled to the processor. The display device is capable of exhibiting a plurality of brightness levels. The system further includes a subsystem for detecting a request to change the brightness level of the display device to one of the plurality of brightness levels, the brightness levels varying non-linearly from brightness level to brightness level.

A principal advantage of the embodiment disclosed herein is that changes in brightness level of display devices appear more consistent to users when brightness settings are adjusted.

Another advantage of the embodiment disclosed herein is that power consumption is reduced under some operating conditions.

### BRIEF DESCRIPTION OF THE DRAWINGS

FIG. 1 is a block diagram of one embodiment of the disclosed information handling system.

FIG. 2 is a flowchart describing the methodology employed in the operation of the information handling system of FIG. 1.

FIG. 3 is a graph depicting linear scaling employed by prior information handling systems to vary brightness and depicting fixed percentage scaling employed by one embodiment of the disclosed information handling system.

### DETAILED DESCRIPTION

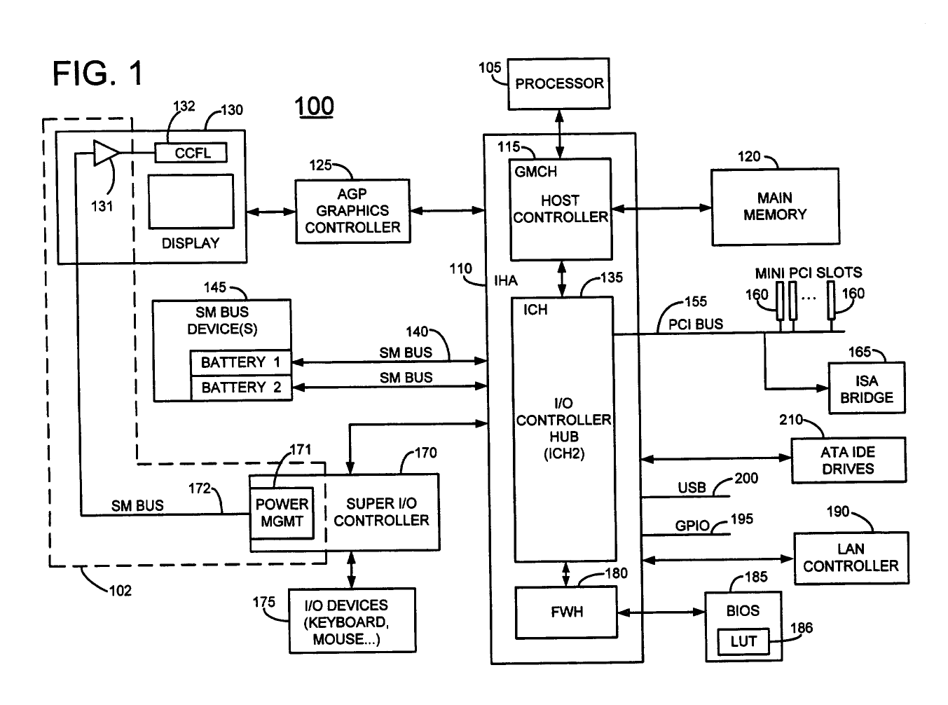

FIG. 1 depicts a high level block diagram of an information handling system 100 in which the disclosed technology is practiced. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The particular information handling system 100 depicted in FIG. 1 is a portable computer which includes a processor 105. An Intel Hub Architecture (IHA) chip 110 provides system 100 with memory and I/O functions. More particularly, IHA chipset 110 includes a AGP Graphics and Memory Controller Hub (GMCH) 115. GMCH 115 acts as a host controller that communicates with processor 105 and further acts as a controller for main memory 120. GMCH 115 also provides an interface to Advanced Graphics Port (AGP) controller 125 which is coupled thereto. A display 130 is coupled to AGP controller 125. IHA chipset 110 further includes an I/O Controller Hub (ICH) 135 which performs numerous I/O functions. ICH 135 is coupled to a System Management Bus (SM Bus) 140 which is coupled to one or more SM Bus devices 145, for example battery 1 and battery 2.

ICH 135 is coupled to a Peripheral Component Interconnect (PCI) bus 155 which is coupled to mini PCI connector slots 160 which provide expansion capability to portable computer 100. A super I/O controller 170 is coupled to ICH 135 to provide connectivity to input devices such as a keyboard and mouse 175 as shown in FIG. 1. A firmware hub (FWH) 180 is coupled to ICH 135 to provide an interface to system BIOS 185 which is coupled to FWH 180. A General Purpose I/O (GPIO) bus 195 is coupled to ICH 135. USB ports 200 are coupled to ICH 135 as shown. USB devices such as printers, scanners, joysticks, etc. can be added to the system configuration on this bus. An integrated drive electronics (IDE) bus 205 is coupled to ICH 135 to connect IDE drives 210 to the computer system.

The particular display 130 included in a representative information handling system 100 is an LCD display device. Display 130 includes a CCFL 132, which is configured to provide backlighting and hence brightness for display 130. Information handling system 100 also includes a brightness control subsystem 102. Subsystem 102 controls the brightness of display 130 by controlling the amount of current supplied to inverter 131. As the amount of current through inverter 131 increases, the light output of CCFL 132 and brightness of display 130 correspondingly increases. Subsystem 102 includes a power management (“PM”) controller 171, and an inverter 131. PM controller 171 may be located in super I/O controller 170, and inverter 131 may be located in display 131 as shown in FIG. 1. PM controller 171 is coupled to inverter 131 via an SM bus 172. Inverter 131 is also coupled to CCFL 132. Inverter 131 may also be referred to as a power regulator or an adjustable current supply.

In one embodiment of information handling system 100, BIOS 185 includes a look up table (LUT) 186, which contains values related to the brightness level for each of the settings, wherein values are not linearly related. An example embodiment of lookup table 186 is shown below as Table 1.

TABLE 1

| BRIGHTNESS | |
|---|---|
| SETTING NO. | BRIGHTNESS |
| (STEP NO.) | LEVEL (in NITS) |
| 1 | 20 |
| 2 | 28.4 |
| 3 | 36.8 |
| 4 | 49.4 |
| 5 | 61.9 |
| 6 | 82.9 |
| 7 | 112.3 |
| 8 | 150 |

In the above table, each number in the left column represents a separate relative brightness setting (step number) and each number in the right column represents a corresponding brightness level of the CCFL measured in NITS. Each brightness level in the right column is approximately a fixed percentage greater than the brightness value immediately preceding it. Thus for brightness setting 1, the corresponding brightness level is 20 NITS, and for brightness setting of 2, the brightness level is 28.4 NITS. This represents a 4.2% increase in brightness level. Similarly, changing from brightness setting 2 to brightness setting 3 results in a change in actual brightness level of 28.4 NITS to 36.8 NITS, another fixed percentage increase of approximately 4.2%.

In this particular embodiment, adjustments in lower brightness settings, such as an adjustment from 1 to 2 (namely 8.4 NITS) or from 2 to 3 (namely 8.4 NITS), cause relatively small changes in actual brightness levels (measured in NITS) as compared to adjustments in the higher brightness settings, such as adjustments from 6 to 7 (namely 29.4 NITS) or from 7 to 8 (namely 37.7 NITS). However, since each brightness level is approximately a fixed percentage of the brightness level immediately preceding it, the change from brightness level to brightness level appears to be approximately linear as perceived by the user.

In actual practice, an inverter current level or regulator current level is stored in LUT 186 corresponding to each brightness setting of Table 1. When the user selects a particular brightness setting, for example brightness setting 2, then a current value or a number corresponding to a current value which produces 28.4 NITS is sent to inverter (regulator) 131. Inverter 131 responds by supplying the specified amount of current to CCFL 132 thus causing CCFL 132 to output 28.4 NITS of light across display 130.

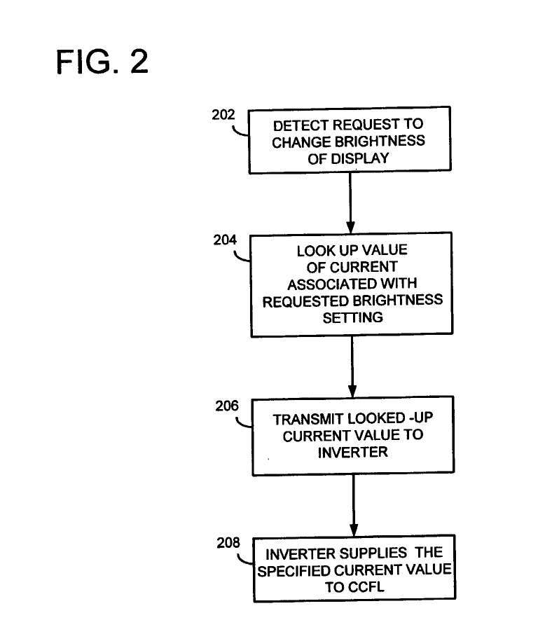

FIG. 2 is a flowchart describing the operation of information handling system 100 in a scenario where brightness settings are adjusted for display 130 in a non-linear fashion from brightness level to brightness level. A request to adjust the brightness setting of display device 130 is detected as indicated by block 202. This request can be made by the user in several different ways. One way is for the user to press the CONTROL-PAGE UP or CONTROL-PAGE DOWN keys. After the request is detected, lookup table 186, which contains values related to the brightness level for each of the possible settings, is consulted as shown in block 204. A value related to the brightness level corresponding to the selected setting number is transmitted to inverter 131 as indicated by block 206. Inverter 131 then supplies the appropriate amount of current to display CCFL 132 to produce the designated number of NITS of brightness as per block 208.

In more detail, one embodiment of the disclosed technology operates in the following manner. Per block 202, a request (which may be transmitted by a keyboard input) to adjust the brightness settings of display 130 up or down is detected by PM controller 171. After the request is detected, PM controller 171 consults lookup table 186 included in BIOS 185 for the brightness level value for the requested setting as indicated in block 204. For example, if the request is to adjust the brightness setting to 4, then PM controller 171 consults lookup table 186 for the brightness level value corresponding to setting 4. According to the example embodiment shown in Table 1, the brightness value is 49.4 NITS. After PM controller 171 locates the brightness level value corresponding to the requested setting (or an inverter/regulator current level or CCFL current level corresponding to that setting), PM controller 171 transmits the retrieved value to inverter 131 via SM bus 172 per block 206. Accordingly, inverter 131 uses the value to adjust the brightness level of CCFL 132 to the designated NIT level as per block 208.

Although lookup table 186 is stored in BIOS 185 in this particular embodiment as shown in FIG. 1, table 186 may be included in other locations. For example, in another embodiment (not shown), table 186 is included in a storage device such as drives 210.

It is noted that information included in Table 1 may be modified to reflect configurations including any number of brightness settings. For example, the number of rows in Table 1 may be increased to 10 if the total number of brightness settings is 10 or may be decreased to 6 if the total number of brightness settings is 6. The number of brightness settings and corresponding current values may be increased or decreased as desired for the particular application.

The scaling employed in Table 1 is non-linear, namely the change in NITS in the output brightness level is non-linear as we increment or decrement from brightness setting to brightness setting. An example of one type of non-linear scaling which may be used in lookup TABLE 1 is one wherein each increment in brightness setting causes an increase in the brightness level by a fixed percentage of the current brightness level. For example, with such a fixed percentage scaling, a brightness setting of 3 would have a corresponding brightness level that is a fixed percentage higher than the brightness level for setting 2, and setting 4 would have a corresponding brightness level that is higher than the brightness level for setting 3 by approximately the same fixed percentage.

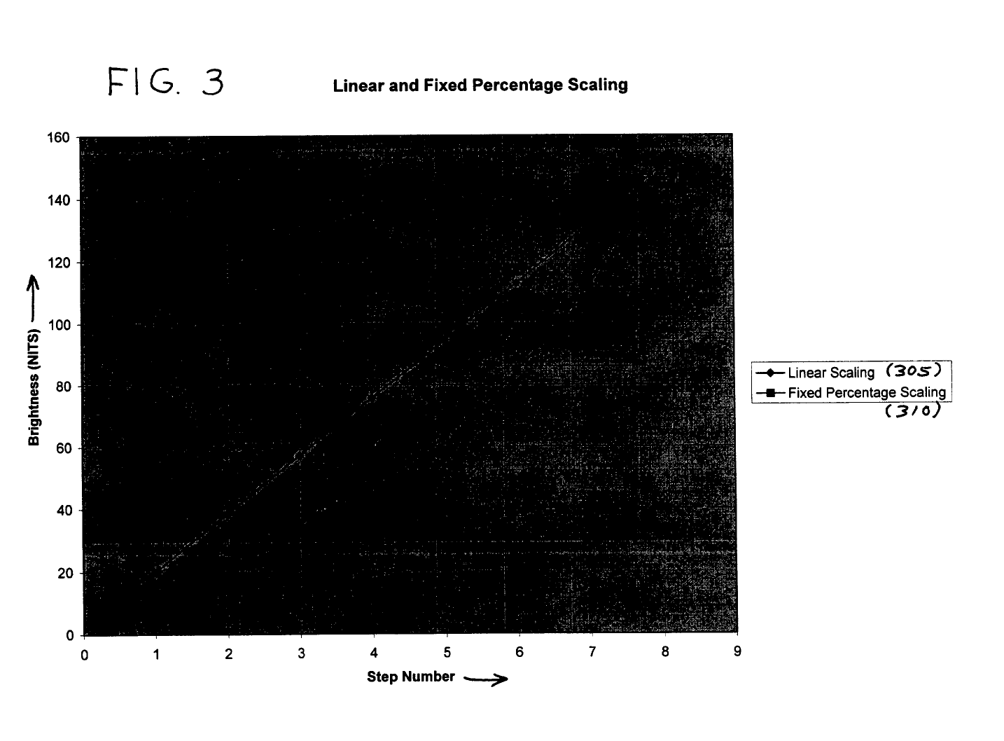

FIG. 3 is a graph of brightness in NITS (y axis) vs. step number (x axis) for the prior linear case (see curve 300) and the disclosed non-linear approach (see curve 305). In the particular non-linear scaling employed for curve 305 in FIG. 3, approximately fixed percentage brightness scaling is employed. It is noted that the resultant curve 305 is approximately exponential.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

What is claimed is:

1. An information handling system comprising:
a processor;
a memory coupled to the processor;
a display device coupled to the processor, the display device being capable of exhibiting a plurality of brightness levels; and
a subsystem for detecting a request to change the brightness level of the display device to one of the plurality of brightness levels, the brightness levels varying non-linearly from brightness level to brightness level.

2. The information handling system of claim 1 further comprising a lookup table for storing values related to the brightness levels.

3. The information handling system of claim 2 wherein the subsystem is capable of detecting a request to adjust the brightness level of the display device to a selected brightness level, the subsystem retrieving from the lookup table a value related to the selected brightness level in response to detecting the request.

4. The information handling system of claim 3 wherein the subsystem transmits the value to the display device.

5. The information handling system of claim 2 wherein the lookup table is stored in a storage device.

6. The information handling system of claim 2 wherein the lookup table is stored in BIOS.

7. An information handling system comprising:
a processor;
a memory coupled to the processor;
a display device coupled to the processor, the display device being capable of exhibiting a plurality of brightness levels; and
a subsystem for detecting a request to change the brightness level of the display device to one of the plurality of brightness levels which vary in brightness by an approximately fixed percentage of brightness from brightness level to brightness level.

8. The information handling system of claim 7 further comprising a lookup table for storing values related to the brightness levels.

9. The information handling system of claim 8 wherein the subsystem retrieves from the lookup table a value related to the selected brightness level in response to detecting the request.

10. The information handling system of claim 9 wherein the subsystem transmits the value to the display device.

11. The information handling system of claim 8 wherein the lookup table is stored in a storage device.

12. The information handling system of claim 8 wherein the lookup table is stored in BIOS.

13. A method of operating an information handling system including a display device, the method comprising:
detecting a request to change the brightness level of the display device to one of a plurality of brightness levels which vary non-linearly with respect to each other; and
instructing the display device to operate at the brightness level designated by the request.

14. The method of claim 13 including the step of storing in a lookup table a plurality of values respectively corresponding to the plurality of brightness levels.

15. The method of claim 14 including the step of storing the lookup table in BIOS.

16. The method of claim 14 including the step of storing the lookup table in a storage device.

17. The method of claim 13 wherein the instructing step includes transmitting to the display device a value related to brightness level indicated in the request.

18. A method of operating an information handling system including a display device, the method comprising:
detecting a request to change the brightness level of the display device to one of a plurality of brightness levels which vary in brightness as an approximately fixed percentage of brightness from brightness level to brightness level; and
instructing the display device to operate at the brightness level designated by the request.

19. The method of claim 18 including the step of storing in a lookup table a plurality of values respectively corresponding to the plurality of brightness levels.

20. The method of claim 19 including the step of storing the lookup table in BIOS.

21. The method of claim 19 including the step of storing the lookup table in a storage device.

22. The method of claim 18 wherein the instructing step includes transmitting to the display device a value related to brightness level indicated in the request.
